(19) United States
(12) Patent Application Publication
(10) Pub. No.: US 2009/0308632 A1
(43) Pub. Date: Dec. 17, 2009

(54) Shielded conductor

(75) Inventor: Kunihiko Watanabe, Yokkaichi-shi (JP)

Correspondence Address: OLIFF & BERRIDGE, PLC, P.O. BOX 320850, ALEXANDRIA, VA, 22320-4850, US

(73) Assignees: AUTONETWORKS TECHNOLOGIES, LTD, YOKKAICHI-SHI (JP); SUMITOMO WIRING SYSTEMS, LTD, YOKKAICHI-SHI (JP); SUMITOMO ELECTRIC INDUSTRIES, LTD, OSAKA-SHI (JP)

(21) Appl. No.: 11/919,252

(22) PCT Filed: Jul. 5, 2006
(86) PCT No.: PCT/JP2006/313407

§ 371 Date: Oct. 25, 2007

(30) Foreign Application Priority Data
Jul. 5, 2005 (JP) 2005-196405

(51) Int. Cl. H01B 9/02

(52) U.S. Cl. 174/106 R; 174/102 R

(57) ABSTRACT

A shielded conductor A comprising a shield pipe 10 made of metal; a flexible shield member 20 which is made of metal and is connected to an end portion of the shield pipe 10; and an electric wire 30 which is shielded by being inserted into the shield pipe 10 and the flexible shield member 20, wherein the shield pipe 10 and the flexible shield member 20 are formed of a metal having a standard electrode potential difference of 1.50 V or less between the shield pipe and the flexible shield member. Preferably, the shield pipe 10 is made of stainless steel, copper or a copper alloy. Preferably, the flexible shield member 20 is made of stainless steel, copper or a copper alloy. Preferably, this shielded conductor A is used in a power circuit of an electric vehicle.

### TECHNICAL FIELD

The present invention relates to a shielded conductor (shielded conductor).

### BACKGROUND ART

Patent document 1 discloses a shielded conductor wherein a shield pipe which is made of metal and is provided with a wire protection function is connected to a flexible shield member composed of a braided wire formed by winding metal element wires into a tubular shape, and a plurality of non-shield electric wires are collectively shielded by being inserted into the shield pipe and the flexible shield member.

Such a shielded conductor is, for example, used in a power circuit of an electric vehicle. When a cabling path runs along the bottom portion of the body of an electric vehicle, a high strength shield pipe is used as a shield means. When a cabling path is limited in space and curved (such as in-vehicle cabling path), a flexible shield member is used as a shield means.

[Patent document 1] Japanese Patent Laid-Open No. 2004-171952

### DISCLOSURE OF THE INVENTION

### Problems to be Solved by the Invention

When a shielded conductor is used in a vehicle, a higher priority is placed on lightweight to improve running performance and the like. Thus, aluminum is preferably used as a material of the shield pipe. On the other hand, in the case of the flexible shield member, weight reduction is less required since its cabling length is relatively short and a higher priority is placed on deformability. In view of this, copper is preferably used as a material of the flexible shield member.

However, aluminum and copper are different in standard electrode potential. Accordingly, there is a problem in that if water or an electrolyte solution is found in a connecting portion between an aluminum shield pipe and a copper flexible shield member, a potential difference occurs between them, and electrical corrosion will occur in the aluminum shield pipe having a low standard electrode potential.

The present invention has been completed on the basis of the above findings, and an object of the present invention is to prevent electrical corrosion from occurring in a connecting portion between a shield pipe and a flexible shield member.

### Means for Solving the Problems

The means for solving the above problems is the following invention:

(1) A shielded conductor comprising:

a shield pipe made of metal;

a flexible shield member which is made of metal and is connected to an end portion of the shield pipe; and

an electric wire which is shielded by being inserted into the shield pipe and the flexible shield member, wherein the shield pipe and the flexible shield member are formed of a metal having a standard electrode potential difference of 1.50 V or less between the shield pipe and the flexible shield member.

(2) The shielded conductor described in the above (1), wherein the shield pipe is made of stainless steel, copper or a copper alloy.

(3) The shielded conductor described in the above (1), wherein the shield pipe is made of stainless steel, and the flexible shield member is made of stainless steel, copper or a copper alloy.

(4) The shielded conductor described in the above (1), wherein the shield pipe is made of stainless steel, and a plated layer made of a material whose standard electrode potential is lower than that of copper and higher than that of iron is formed on the surface of the flexible shield member.

(5) The shielded conductor described in the above (4), wherein a tin plating layer is formed on the surface of the flexible shield member.

(6) The shielded conductor described in any one of the above (1) to (5), which is used in a power circuit of an electric vehicle.

(7) The shielded conductor described in the above (6), wherein the shield pipe is placed along the bottom portion of the body of an electric vehicle.

### ADVANTAGES OF THE INVENTION

According to the shielded conductor of the present invention, the shield pipe and the flexible shield member are formed of a metal having a standard electrode potential difference of 1.50 V or less between them. Accordingly, electrical corrosion is difficult to proceed in a contact portion between the shield pipe and the flexible shield member. The reason why the standard electrode potential difference is set to 1.50 V or less is because electrical corrosion is difficult to proceed between the same or different kinds of metals having a standard electrode potential difference in this range.

According to the shielded conductor of the present invention, the shield pipe is made of stainless steel, copper or a copper alloy. Therefore, compared to a conventional shielded conductor having an aluminum shield pipe, electrical corrosion is more difficult to proceed in a contact portion between the shield pipe and the flexible shield member.

According to the shielded conductor of the present invention, the shield pipe is made of stainless steel, and the flexible shield member is made of stainless steel, copper or a copper alloy. Therefore, it is possible to provide a standard electrode potential difference of 1.50 V or less or 0 V, and thus electrical corrosion is difficult to proceed in a contact portion between the shield pipe and the flexible shield member.

It should be noted that the standard electrode potential of copper is +0.34 V, the standard electrode potential of iron contained in stainless steel is −0.44 V, and the difference in standard electrode potential between copper and iron is 0.78 V. On the other hand, the standard electrode potential of aluminum is −1.66 V and the difference in standard electrode potential between copper and aluminum is 2.00 V. Accordingly, the difference in standard electrode potential is expected to be small only approximately 1.22 V by changing the material of the shield pipe from the conventional aluminum to stainless steel.

According to the shielded conductor of the present invention, when the shield pipe is made of copper or a copper alloy, the difference in standard electrode potential between the shield pipe and the flexible shield member can be zero, and thus electrical corrosion can be prevented from occurring.

According to the shielded conductor of the present invention, the difference in standard electrode potential between the plated layer and iron is smaller than the difference in standard electrode potential between copper and iron, and thus electrical corrosion can be more securely prevented from proceeding in a contact portion between the shield pipe and the flexible shield member.

According to the shielded conductor of the present invention, it is possible to provide a reliable power circuit of an electric vehicle.

### BRIEF DESCRIPTION OF THE DRAWINGS

FIG. 1 is a longitudinal sectional view of the shielded conductor;

FIG. 2 is a cross-sectional view of the shielded conductor; and

FIG. 3 is an enlarged partial sectional view of the shielded conductor.

### DESCRIPTION OF THE SYMBOLS

A Shielded conductor

10 Shield pipe

20 Flexible shield member

22 Plated layer

30 Electric wire

### BEST MODE FOR CARRYING OUT THE INVENTION

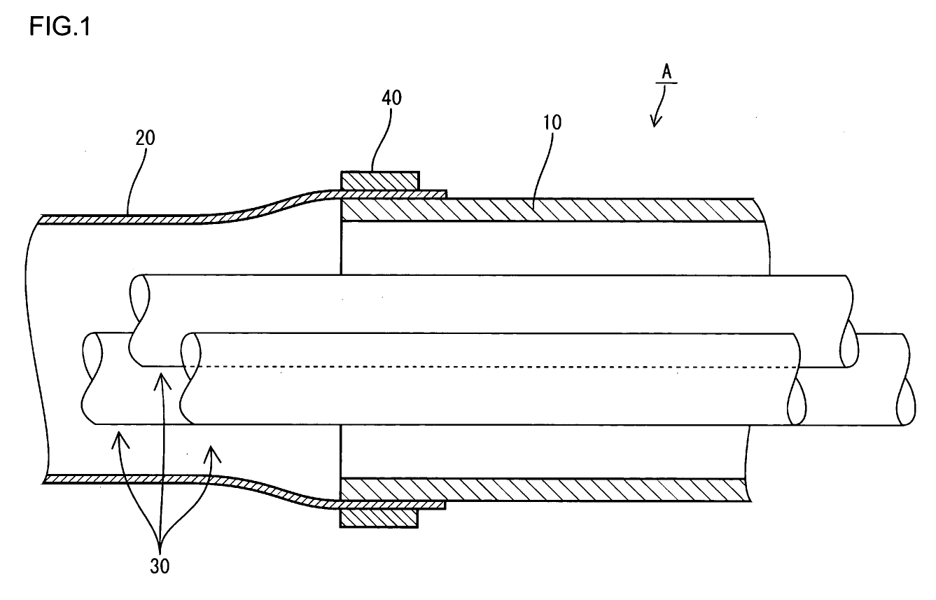

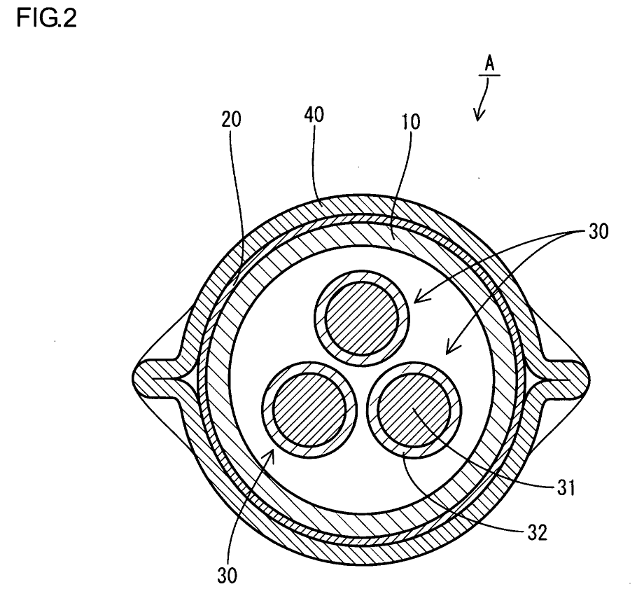

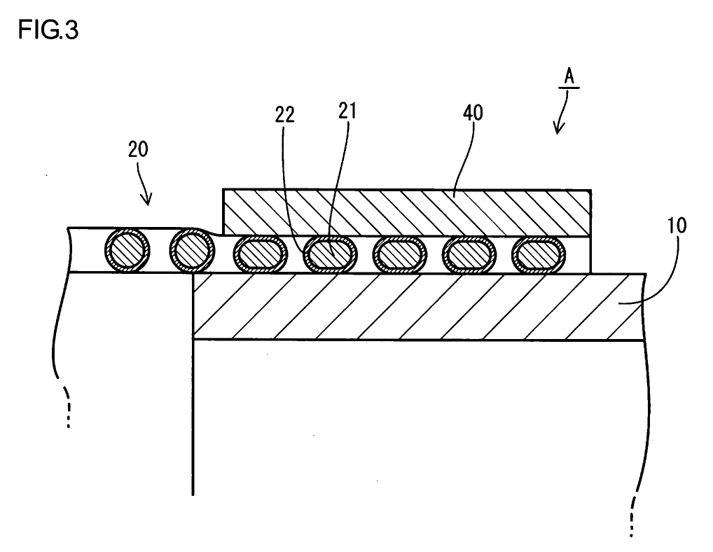

Hereinafter, embodiments of the present invention will be described with reference to FIGS. 1 to 3. A shielded conductor A of this embodiment comprises a shield pipe 10 having both a package shielding function and an electric wire protection function; a flexible shield member 20 having the package shielding function; and a plurality of (three in this embodiment) non-shield type electric wires 30.

The shield pipe 10 is made of metal and has a circular cross section. The flexible shield member 20 is formed of element wires 21 made of copper or a copper alloy. The element wires 21 are formed into a mesh tubular braided wire. The flexible shield member 20 can be freely bent and deformed. A tin plating layer 22 is formed on the surface of each element wire 21. The rear end portion of the flexible shield member 20 (end portion shown at right hand side in FIG. 1) is placed on a periphery of the front end portion of the shield pipe 10. The rear end portion of the flexible shield member 20 is conductably fastened to the shield pipe 10 by a caulking ring 40 made of a copper alloy or stainless steel.

An electric wire 30 has a known shape. The electric wire 30 has an electrically conductive wire 31 which is composed of an aluminum alloy single core wire, a copper twisted wire, or the like. A plastic insulating coating 32 is coated surrounding the periphery of the electrically conductive wire 31. Both the electrically conductive wire 31 and the insulating coating 32 have a flexibility. Thus the electric wire 30 can be bent and deformed. A plurality of electric wires 30 are inserted into the shield pipe 10 and the flexible shield member 20. The electric wires 30 are collectively shielded by the shield pipe 10 and the flexible shield member 20.

It should be noted that the element wire 21 of the flexible shield member 20 and the shield pipe 10 are made of different metals, and both metals have different standard electrode potentials. If an electrolyte solution such as water is found in a contact portion between the shield pipe 10 and the flexible shield member 20, a potential difference will occur between them, and electrical corrosion will occur in a metal having a low standard electrode potential. The smaller the standard electrode potential of the two contacting metals, the more slowly electrical corrosion will proceed. In view of this point, this embodiment uses stainless steel as a material of the shield pipe 10.

The plated layer 22 which is formed on the surface of the element wire 21 of the flexible shield member 20 is made of tin. The standard electrode potential of tin is “−0.14 V” and the standard electrode potential of iron contained in stainless steel used as a material of the shield pipe 10 is “−0.44 V”. Accordingly, the potential difference in a contact portion between the flexible shield member 20 and the shield pipe 10 is small, only “0.30 V”. On the other hand, if the shield pipe 10 is made of aluminum, having a standard electrode potential of “−1.66 V”, the potential difference in a contact portion between the flexible shield member 20 and the shield pipe 10 will increase to “1.52 V”. Therefore, according to this embodiment, electrical corrosion in a contact portion between the plated layer 22 of the flexible shield member 20 and the shield pipe 10 will proceed slower than if the shield pipe 10 is made of aluminum.

In addition, even if the plated layer 22 is not formed on the surface of the element wire 21, electric corrosion can be prevented from proceeding when the element wire 21 made of copper or a copper alloy is directly contacted with the surface of the shield pipe 10. This is because, compared to the difference in standard electrode potential between the shield pipe 10 made of aluminum and the flexible shield member 20 made of copper or a copper alloy (2.00 V), the difference in standard electrode potential between the shield pipe 10 made of stainless steel and the flexible shield member 20 made of copper or a copper alloy is small, only approximately 0.78 V.

According to this embodiment, the shield pipe 10 is made of stainless steel. Thus, the potential difference in a contact portion between the flexible shield member 20 and the shield pipe 10 decreases, and electric corrosion can be prevented from proceeding.

More specifically, when the Method for Moisture Rain & Spray Test for Automobile Parts, the Salt Spray Testing and the like defined by JIS are performed, electrical characteristics of a contact portion can be satisfied by performing a simple waterproof treatment such as taping which is extensively used as wire harness for vehicles.

In addition, because the plated layer 22 made of tin whose standard electrode potential is lower than that of copper forming the element wire 21 and higher than that of iron contained in stainless steel is formed on the surface of the element wire 21 of the flexible shield member 20, the potential difference between the plated layer 22 and iron becomes smaller than the potential difference between copper and iron. Thus, electric corrosion can be more securely prevented from proceeding than if the plated layer 22 is not formed.

The shield pipe 10 and the flexible shield member 20 are formed by metals having a standard electrode potential difference of 1.50 V or less between them. Accordingly, electrical corrosion in a contact portion between the shield pipe 10 and the flexible shield member 20 can be prevented from proceeding.

For example, the shield pipe 10 can be made of stainless steel, copper or a copper alloy, and the flexible shield member 20 can be made of stainless steel, copper or a copper alloy. In this case, the difference in standard electrode potential between the metals forming the shield pipe 10 and the metals forming the flexible shield member 20 can be 1.50 V or less.

For example, the shield pipe 10 can be made of stainless steel and the flexible shield member 20 can be made of stainless steel, copper or a copper alloy. In this case, the difference in standard electrode potential between the metals forming the shield pipe 10 and the metals forming the flexible shield member 20 can be 1.50 V or less.

The difference in standard electrode potential can be zero by forming the shield pipe 10 and the flexible shield member 20 with the same kind of metal. For example, the difference in standard electrode potential can be zero by the shield pipe 10 made of copper or a copper alloy and the flexible shield member 20 made of copper or a copper alloy. Accordingly, electrical corrosion in a contact portion between the shield pipe 10 and the flexible shield member 20 can be more securely prevented from proceeding.

The shielded conductor A of this embodiment can be used, for example, as a power circuit of an electric vehicle. For example, when a cabling path runs along the bottom portion of the body of an electric vehicle, a high strength shield pipe 10 can be used as a shield means, and when a cabling path is limited in space and curved (such as in-vehicle cabling path), the flexible shield member 20 can be used as a shield means. Accordingly, it is preferable to place the shield pipe 10 along the bottom portion of the body of an electric vehicle.

### THE OTHER EMBODIMENTS

The present invention is not limited to the aforementioned description and the embodiment described with reference to the drawings. For example, the following embodiments are also included in the technical scope of the present invention. Further, in addition to the following, various modifications can be made without departing from the scope of the present invention.

(1) According to the above embodiment, a caulking ring is separated from the shield pipe and the flexible shield member, and the caulking ring is used as a means for connecting the flexible shield member with the shield pipe, but the present invention is not limited to what is shown in this embodiment. For example, a part of the shield pipe may be bent so as to fold back toward the peripheral side of itself and then may clamp the flexible shield member by the bent portion. This enables the flexible shield member to be firmly fixed to the shield pipe.

(2) The above embodiment shows an example in which the flexible shield member is in contact with the outer peripheral surface of the shield pipe, but the present invention is not limited to this embodiment. For example, the flexible shield member may be in contact with the inner peripheral surface of the shield pipe to connect both materials.

(3) The above embodiment shows an example in which the cross-sectional shape of the shield pipe is generally circular, but the present invention is not limited to this embodiment. For example, the cross-sectional shape of the shield pipe may be noncircular (such as elliptical and oval).

(4) The above embodiment shows an example in which the flexible shield member is a braided wire, but the present invention is not limited to this embodiment. For example, the flexible shield member may be a sheet material made of copper or a copper alloy.

(5) The above embodiment shows an example in which three electric wires are inserted into one shield pipe, but the present invention is not limited to this embodiment. For example, two or less or four or more electric wires may be inserted into one shield pipe.

(6) The above embodiment shows an example in which a plated layer is formed on the surface of the flexible shield member, but the present invention includes an example in which a plated layer is not formed on the surface of the flexible shield member.

(7) The above embodiment shows an example in which a plated layer formed on the surface of the flexible shield member is made of tin, but any other metal may be used, provided that its standard electrode potential is lower than that of copper and higher than that of iron.

### INDUSTRIAL APPLICABILITY

The present invention relates to a shielded conductor, for example, which is used in a power circuit and the like of an electric vehicle, and has an industrial applicability.

1. A shielded conductor comprising:
a shield pipe made of metal;
a flexible shield member which is made of metal and is connected to an end portion of said shield pipe; and
an electric wire which is shielded by being inserted into said shield pipe and said flexible shield member,
wherein said shield pipe and said flexible shield member are formed of a metal having a standard electrode potential difference of 1.50 V or less between said shield pipe and said flexible shield member.

2. The shielded conductor according to claim 1, wherein said shield pipe is made of stainless steel, copper or a copper alloy, and said flexible shield member is made of stainless steel, copper or a copper alloy.

3. The shielded conductor according to claim 1, wherein said shield pipe is made of stainless steel, and said flexible shield member is made of stainless steel, copper or a copper alloy.

4. The shielded conductor according to claim 1, wherein said shield pipe is made of stainless steel, and a plated layer made of a material whose standard electrode potential is lower than that of copper and higher than that of iron is formed on the surface of said flexible shield member.

5. The shielded conductor according to claim 4, wherein a tin plating layer is formed on the surface of said flexible shield member.

6. The shielded conductor according to claim 1, which is used in a power circuit of an electric vehicle.

7. The shielded conductor according to claim 6, wherein said shield pipe is placed along the bottom portion of the body of an electric vehicle.

8. The shielded conductor according to any one of claim 2, which is used in a power circuit of an electric vehicle.

9. The shielded conductor according to any one of claim 3, which is used in a power circuit of an electric vehicle.

10. The shielded conductor according to any one of claim 4, which is used in a power circuit of an electric vehicle.

11. The shielded conductor according to any one of claim 5, which is used in a power circuit of an electric vehicle.
